(19) United States
(12) Patent Application Publication
(10) Pub. No.: US 2005/0264545 A1
(43) Pub. Date: Dec. 1, 2005

(54) Method and system for determining the location of a movable icon on a display surface

(76) Inventor: Ray Allen Walker, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/855,826

(22) Filed: May 27, 2004

(51) Int. Cl. G09G 5/00

(52) U.S. Cl. 345/204

(57) ABSTRACT

A method of determining the location of a movable icon on a display surface in a digital light projection system is disclosed. The method includes projecting modulated light to the display surface to generate a viewable image and projecting an identifiable optical signal to the display surface with the viewable image such that said viewable image is not observably degraded. The identifiable optical signal is receivable by the icon on the display surface.

### BACKGROUND

Digital light projection (“DLP”) systems are gaining popularity in various contexts, including residential and commercial environments. For example, digital light projection systems are more commonly being used to display television, motion pictures, and computer graphics on a display surface. Some projection systems are “front projection” systems, and some projection systems are “rear projection” systems. “Rear projection” systems project digital images to the rear side of a transparent display surface, and the image is viewed by a person from the front side of the display surface.

Sometimes, rear digital light projection systems are used to display images and graphics generated by a computer or other electronic controller. For example, computer images and graphics traditionally displayed on CRTs and flat screen monitors can be displayed on a transparent display surface using a rear digital light projection system. For some applications—such as computer gaming, computer applications, and various interactive video applications—it would be useful to be able to have detached (movable) objects (“icons”) in contact with the transparent display surface and for the system computer or controller to be able to communicate with the icons. For example, it would sometimes be desirable to be able to accurately determine the location or position of one or more icons on the display surface. In one exemplary application where a rear projection display system is used in a gaming context, detached icons in the form of game pieces may be placed on the display surface of the system, and, to facilitate interaction between the detached game pieces and a controller running the game, it would be desirable for the controller or computer to be able to determine the location of the game pieces on the image surface.

Heretofore, techniques have existed for locating detached icons on the display surface of a raster scan projection system (common in conventional television systems). In raster scan systems, a detached icon having a sensor would detect the horizontal and vertical phase of the icon's sensed position relative to the horizontal and vertical synchronization signals of the raster scan system. However, DLP systems do not project images in a raster manner. Thus, it is not possible to locate an icon on the image surface of a DLP system using techniques traditionally used in connection with raster systems.

The embodiments described hereinafter were developed in light of this situation and the drawbacks associated with existing systems.

### BRIEF DESCRIPTION OF THE DRAWINGS

The present invention will now be described, by way of example, with reference to the accompanying drawings, in which:

FIG. 1 illustrates an interactive display system according to an embodiment;

FIG. 2 is a schematic view of an exemplary digital light projection system, controller, and display surface used in an embodiment of the interactive display system of FIG. 1;

FIG. 3 is a close-up view of a portion of an exemplary digital micro-mirror device used in a digital light processor, according to one embodiment, used in the interactive display system shown in FIGS. 1 and 2;

FIG. 4 illustrates an exemplary color wheel used in a digital light projection system, according to an embodiment;

FIG. 5A illustrates an exemplary image signal for a single pass of the color blue on the color wheel.

FIG. 5B illustrates an exemplary modified image signal for a single pass of the color blue on the color wheel, illustrating a signaling period and a data period.

FIG. 6 illustrates a display surface and a vertical probing column and a horizontal probing column, used to determine locations of icons on the display surface.

FIG. 7 illustrates a display surface divided into four exemplary quadrants for improving a described method for determining the locations of icons on the display surface.

### DETAILED DESCRIPTION

A system and a method for determining the location of a detached icon on the display surface of a digital light projection (DLP) system are disclosed. The system includes a DLP and a display surface, such as a glass or plastic screen, and a computer or electronic controller. The DLP projects digital images onto the display surface in response to control signals provided by a computer or controller. Each image is comprised of a multitude of pixels, normally millions of pixels. Detached icons are positioned on the display surface, but are independently moveable over the display surface by a user. The icons may take various forms, such as pointing devices, game pieces, computer mice, etc., that include an optical receiver and a transmitter of some sort.

The DLP sequentially projects a series of visible images (frames) to the display surface to generate a continuous moving video or graphic, such as a movie video, a video game, computer graphics, Internet Web pages, etc. The DLP also projects subliminal optical signals interspersed among the visible images. The subliminal signals are invisible to the human eye. However, optical receivers within the icons receive the encoded subliminal optical signals. In this way, the computer or controller can communicate information to the icons in the form of optical signals via the DLP and the display surface. To determine the physical location of one or more icons on the display surface, the controller transmits one or more unique locating signals to the display surface, using various methodologies (described in detail hereinafter). When an icon receives a locating signal, the icon can send a unique feedback signal (using various techniques and mechanisms) to the computer or controller, effectively establishing a “handshake” between the controller and the particular icon. As a result of the unique feedback signals, the controller knows where each of the icons is located on the display surface. Once the computer or controller knows where the different icons on the display surface are located, various actions can be taken, including establishing communication between the controller and the icons.

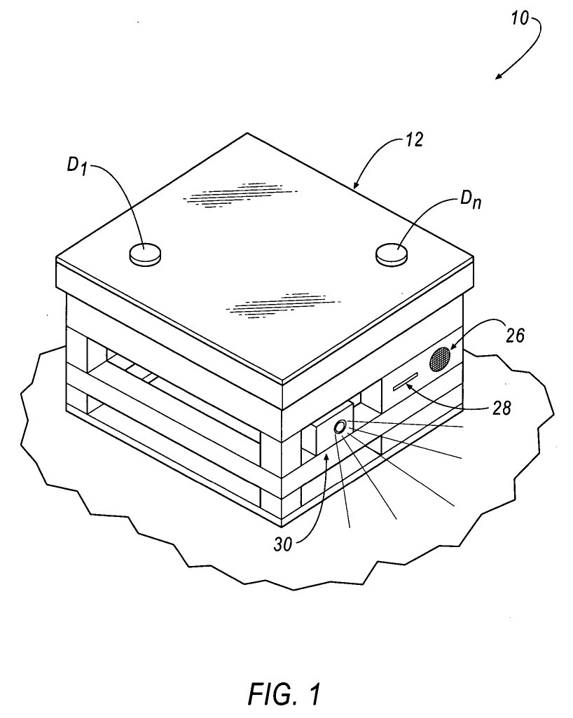

Referring now to FIG. 1, an interactive display system 10 is shown according to an embodiment. In this particular embodiment, the interactive display system 10 is shown as embodied in a “table”, where a transparent table top functions as a display surface 12. In this way, multiple users or players can view and access the display surface 12 by sitting around the table. The physical embodiment, though, can take many forms other than a “table.” A digital light processor (DLP) (not shown in FIG. 1) and a controller (not shown in FIG. 1) cooperate to generate digital light images on the display surface 12, as explained in more detail below. The display surface 12 is a transparent or semi-transparent surface, such as glass or plastic, which allows the digital light images to be projected therethrough. One or more detached icons D1, D_{N} are positioned on the display surface 12. The detached icons D1, D_{N} are independently moveable by a user. Several additional optional features of the system are shown in FIG. 1, such as a secondary projector 30, which could be used to simultaneously display the digital light images into a large vertical screen, a storage medium 28, such as a magnetic or optical disk drive, and a speaker 26.

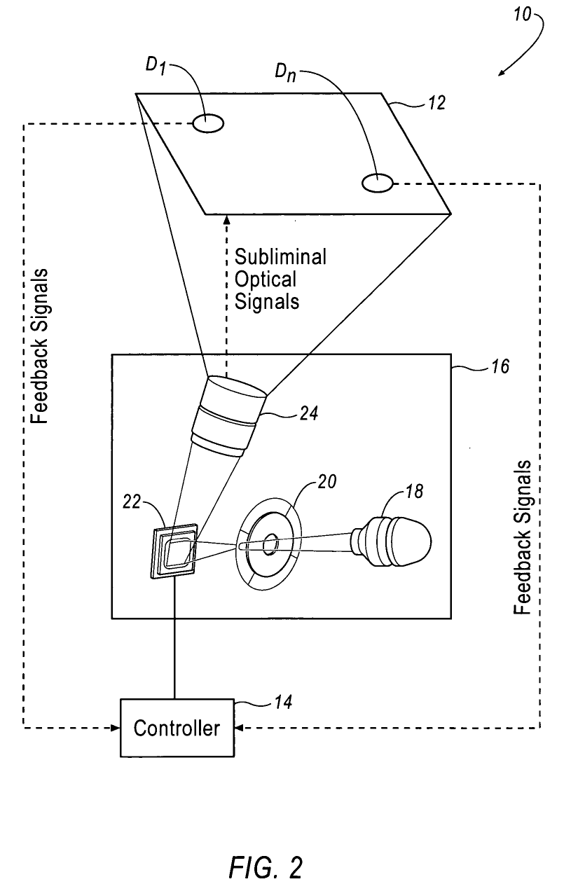

FIG. 2 schematically illustrates a controller 14, a DLP 16, and the display surface 12 that are included in the interactive display system 10 in FIG. 1. The DLP 16 may be housed within the interactive display device 10 such that the DLP 16 is configured to generate digital light images on the display surface 12 in response to control signals from controller 14. The DLP 16 includes a light source 18, a spinning color wheel 20, a digital micro-mirror device (DMD) 22 and a lens system 24. As known by persons skilled in the art, the light source 18 projects light through the spinning color wheel 20 onto the DMD 22. FIG. 4 illustrates an exemplary spinning color wheel 20, which, in this embodiment, has four different color quadrants: white, red, green, and blue. The DMD modulates the colored light, which is reflected through lens system 24 to generate color digital images on display surface 12. The controller 14 controls the operation of the DMD 22 to generate desired images, such as computer graphics, movie video, video games, Internet Web pages, etc., on the display surface 12. The DMD 22 also projects subliminal optical signals to the display surface 12 in response to control signals from the controller 14. The icons D1, D_{N} receive the subliminal optical signals and provide responsive feedback signals to the controller 14, as described in more detail below. The controller 14 may take several forms, such as a personal computer, microprocessor, or other electronic devices capable of providing image signals to a DLP.

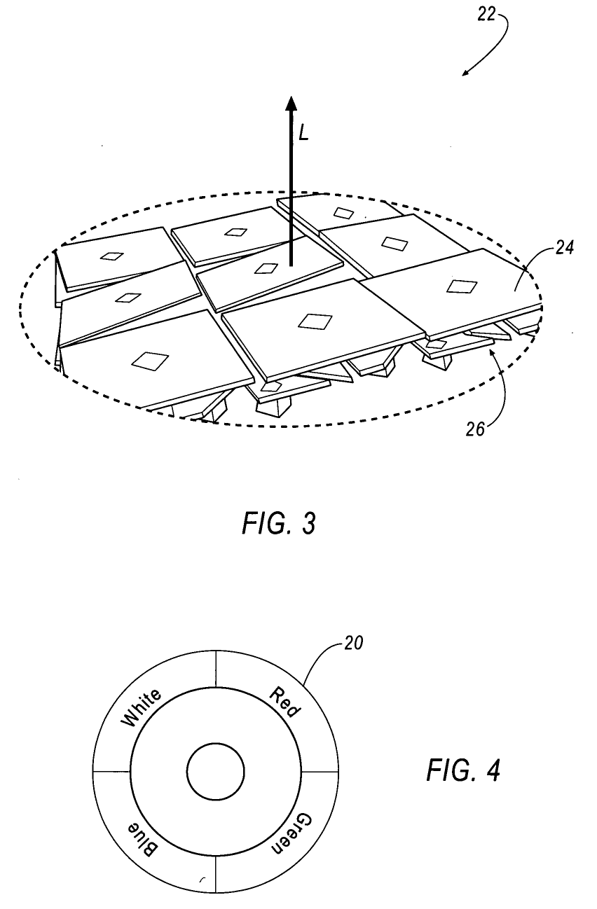

A close-up view of a portion of an exemplary DMD 22 used in the described embodiment is illustrated in FIG. 3. As shown, the DMD 22 includes an array of micro-mirrors 24 individually mounted on hinges 26. Each micro-mirror 24 corresponds to one pixel in an image projected on the display surface 12. The controller 14 (FIG. 2) provides image signals indicative of a desired viewable image to the DLP 16. The DLP 16 causes each micro-mirror 24 of the DMD 22 to modulate light (L) in response to the image signals to generate an all-digital image on the display surface 12. Specifically, the DLP 16 causes each micro-mirror 24 to repeatedly direct light from the light source 18 (FIG. 2) in response to the image signals from the controller 14, effectively turning the particular pixel associated with the micro-mirror “on” and “off”, which normally occurs thousands of times per second for each color on the color wheel 20. A given micro-mirror 24 is switched “on” more frequently than “off” to generate a more predominate shade of the reflected light color, and the micro-mirror 24 is switched “off” more frequently than “on” to generate a less predominate shade of the reflected light. By mixing different portions of the basic colors on the color wheel 20 during the time that an image frame is projected to the display surface 12, each pixel on display surface 12 can take on many different viewable colors.

While the DLP 16 has been described herein as including a DMD 22, other embodiments could include diffractive light devices (DLD), liquid crystal on silicon devices (LCOS), plasma displays, and liquid crystal displays, to name a few. Other spatial light modulator and display technologies are known to those of skill in the art and could be substituted and still meet the spirit and scope of the invention.

The icons D1, D_{N} (FIGS. 1 and 2) can take a variety of forms. In general, each icon has an outer housing and includes both a receiver and a transmitter, which are normally integrated into the input device. The receiver is an optical receiver configured to receive optical signals from the DLP 16 through the display surface 12. For example, the optical receiver may be a photo receptor such as a photocell, photo diode or a charge coupled device (CCD) embedded in the bottom of the input device. The transmitter, which is configured to transmit data to the controller 14, can take many forms, including a radio frequency (RF, such as Bluetooth™) transmitter, an infrared (IR) transmitter, an optical transmitter, a hardwired connection to the controller (similar to a computer mouse), etc. The icons D₁, D_{N} can also take a variety of physical forms, such as pointing devices (computer mouse, white board pen, etc.), gaming pieces, and the like. The icons D₁, D_{N} provide input information, such as their respective physical position on the display surface, etc., to the controller 14 via their respective transmitters. The icons D₁, D_{N} are configured to receive signals from the DLP 16, such as locating signals, via their respective receivers, as will be described in greater detail below. In some embodiments, the icons may include components in addition to the receiver and the transmitter, such as a processor of some sort to interpret and act upon the signals received by the receiver and to drive the transmitter in transmitting information to the controller 14. Further, in another embodiment, each icon may include a light filter of some sort that only allows light of a certain color or intensity to pass through, which may be beneficial for interacting with the system to receive the encoded optical signals from the DLP.

In operation, image data is provided to the controller 14 from one of a variety of sources, including magnetic storage devices (such as hard disks), optical storage devices (such as CD-ROM and DVD), flash memory, local and wide area networks (such as the Internet), etc. The controller 14 processes the image data to control the DLP 16 to project the viewable images represented by the image data to the display surface 12. The controller 14 also causes the DLP 16 to project subliminal optical signals to the display surface 12, as described in more detail below. Each icon D₁, D_{N} is configured to receive the subliminal optical signals (via the icons' optical receivers) when the subliminal optical signals are transmitted to the pixel(s) of the display surface 12 over which the icon is positioned. Each icon D₁, D_{N} can send feedback signals to the controller 14 using a variety of mechanisms, such as IR, RF, optical, hard wires, etc. Where the feedback signals are communicated using wireless methods (e.g., IR, RF, optical, etc.), the controller 14 receives the wireless signals via an appropriate receiver (not shown). Where the feedback signals are communicated optically, the optical receiver may be positioned in the system off-axis relative to the light modulating device (e.g., the DMD) such that the feedback signals can be communicated optically from the icons to the optical receiver through the display surface 12.

Subliminal optical signals may be projected to the display surface 12 interspersed with the digital light image, without noticeably degrading the digital light image to the human eye, using various techniques. In one embodiment, subliminal optical signals are projected to each pixel on the display surface 12. This can be accomplished, for example, by individually controlling each of the micro-mirrors 24 when implemented in an embodiment using a DMD 22. For a given image frame projected to the display surface 12, the controller 14 may use a small portion of the time period that the image frame is displayed on the screen to cause the DLP 16 to project a subliminal optical signal, leaving the remaining portion of the time period for the DLP 16 to project the appropriate color for the given pixel to generate the desired image for the frame. This methodology is now described in more detail.

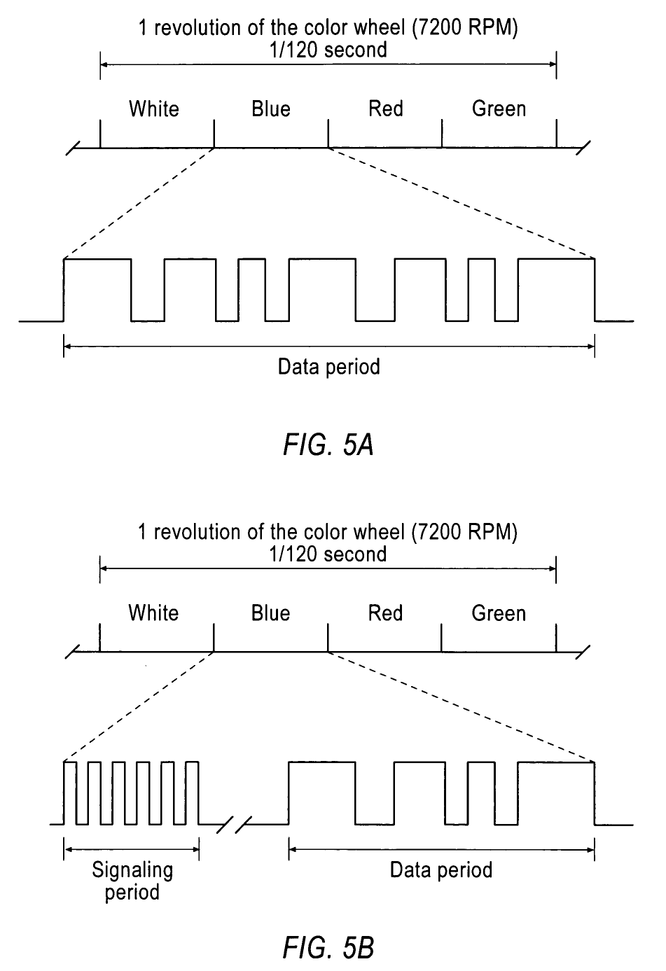

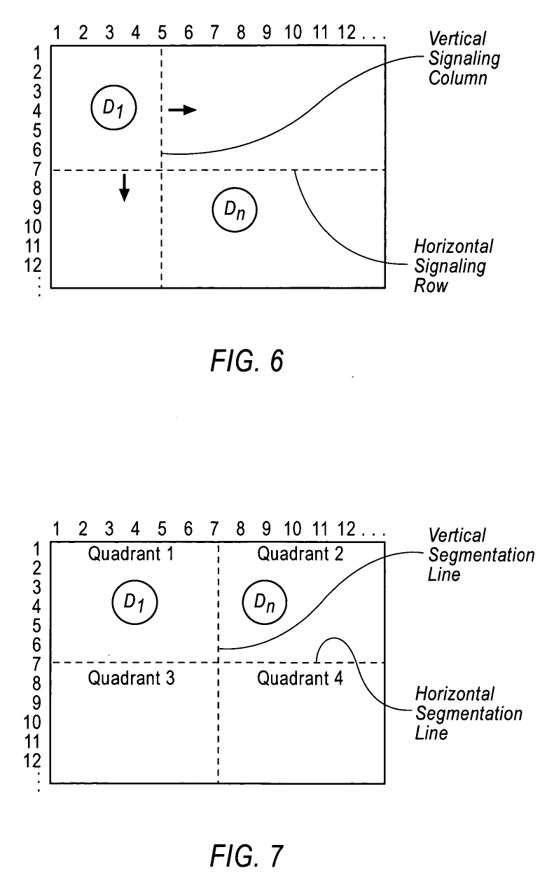

A single revolution of the exemplary color wheel 20 (FIG. 4) is shown schematically in FIGS. 5A and 5B. Each of the exemplary colors (white, blue, red and green) sequentially passes in front of the light source 18 (FIG. 2) for an equal amount of time. By way of example, if the color wheel 20 is rotating at 7200 RPM, each color will pass in front of the light source 18 for a quarter of 1/120 of a second. If a moving image or computer graphic projected by the display system comprises 30 frames per second, each color of the color wheel passes in front of the light source 4 times for each frame (120 times per second). FIG. 5A shows an exemplary image signal for a single pixel for a single passing of blue (on the color wheel) in front of the light source 18. As can be seen in FIG. 5A, controller 14 normally turns a given pixel between “on” and “off” to generate a desired shade of blue. In systems employing a DMD 22, this is accomplished by turning the micro-mirror 26 (FIG. 3) associated with a given pixel “on” and “off” an appropriate portion of the time that the blue color wheel intercepts the light source 18 to generate the desired shade of blue. The controller 14 similarly continuously controls the given pixel between “on” and “off” for each of the other colors on the color wheel, mixing the different shades of the basic colors together to generate the precise desired color for the given pixel.

FIG. 5B illustrates an exemplary way to modify the “on”/“off” cycle for a given pixel to generate a subliminal optical signal. Taking the color blue on the color wheel as an example again, the time period that blue is in front of the light source 18 can be divided up into two constituents: (i) a signaling period, and (ii) a data period. The signaling period can be used to project a unique optical “locating signal” to the display surface 12 that would be recognizable to an optical receiver in the icons D1, D_{N}. The data period can be used to project the appropriate color shade to generate the desired viewable image on the display surface 12. Generally, to prevent significant noticeable degradation of the viewable image, the signaling period constitutes a shorter duration than the data period. Other methods of preventing noticeable degradation of the viewable image are possible and within the scope and spirit of the invention. Considering FIGS. 5A and 5B together, if the “on”/“off” cycle of a given pixel would normally be controlled according to the pulse train shown in FIG. 5A to generate a particular shade of blue for a given pixel for a particular frame, the “on”/“off” cycle could be adjusted according to FIG. 5B to initially send a subliminal optical locating signal to the display surface 12 (during the signaling period) before actually projecting the desired shade of blue to the display surface 12 (during the data period). The optical locating signal can be a unique signal, such as a unique frequency, duty cycle, phase, amplitude, or color, for example, which is recognizable by the icons D1, D_{N}. If an icon D1, D_{N} is physically located on the display surface 12 above the signaling pixel, the icon D1, D_{N} would receive the subliminal optical signal, and, in response, would transmit a feedback signal to the controller 14. In this way, two-way communication between the controller 14 and the icons D1, D_{N} can be established.

The method of communication described above can be implemented for various purposes. In one embodiment, the communication method is used by the controller 14 to determine the physical locations of the icons D1, D_{N} on the display surface 12. In general, the method of projecting a unique optical locating signal during a signaling period can be implemented in various repetitive algorithms to “probe” the pixels of the display surface 12 until the respective physical location of each of the icons is determined. One such method of “probing” the display surface 12 is as follows. For a particular area of the display surface 12, the controller 14 could cause each pixel in a vertical column (the “probing column”) to simultaneously project a unique locating signal to the display surface 12. At a different time, the controller 14 could cause each pixel in a horizontal row (the “probing row”) to simultaneously project the unique locating signal to the display surface 12. The controller 14 could cause the vertical probing column and horizontal probing row to systematically “move” across the display surface 12 over time. For instance, the vertical probing column could “move” from column 1 to column 2 (i.e., “column by column”), and so on, until each of the columns in a given area had been probed with the locating signal. Similarly, the horizontal probing row could “move” from row 1 to row 2 (i.e., “row by row”), and so on, until each of the rows in the area had been probed with the locating signal. At any given time, only a single row or a single column would be probed. Thus, for example, the controller 14 could cause a subsequent column to be probed each time the colors blue and red passed in front of the light source and to cause a subsequent row to be probed each time the colors white and green passed in front of the light source. Each time an icon D1, D_{N} receives a probing signal, the receiving icon transmits a unique feedback signal to the controller 18 that is indicative of the ID of the icon. The controller 14 records the respective display surface coordinate each time an icon sends its unique feedback signal to the controller 14 (indicating that the icon was physically located over the signaling pixel). By correlating the recorded horizontal and vertical coordinate for each of the icons D1, D_{N} on the display surface 12, the physical location of each icon can be uniquely determined by the controller 14.

In some embodiments, the entire display surface 12 will be systematically probed—column by column and row by row—until all of the icons D1, D_{N} are located. In other embodiments, the above-described methodology can be used in connection with other probing methods to increase the efficiency of the probing. For instance, as shown in FIG. 7, the display surface 12 may be divided up into a plurality of initial search areas. In FIG. 7, the display surface is divided into four quadrants by way of example. All of the pixels in each of the four quadrants could first be simultaneously probed, one quadrant at a time (i.e., “quadrant by quadrant” or “area by area”). If the controller 14 does not receive any feedback signal when the pixels of a given quadrant are probed, then it is known that none of the icons D1, D_{N} on the display surface are physically located in that quadrant. Subsequently, when the controller 14 implements the column by column and row by row probing of the display surface 12, certain groups of rows and/or columns may not need to be probed (if it is known that no icons D1, D_{N} are located in a particular quadrant), thereby decreasing the necessary probing time and increasing the efficiency of the algorithm. Whichever method of locating icons D1, D_{N} on the display surface 12 is used, it is normally continuously repeated in order to track the icons as users move the icons on the display surface 12.

In the embodiment described above, the display surface 12 is probed by projecting a unique locating signal to the display surface 12 during the signaling period of each color projected to the display surface, and the actual desired shade of the particular color is projected to the display surface 12 during the data period. This methodology works well for probing the display surface 12, and it is particularly useful when the icons are not covering the pixel(s) being probed. The above-described methodology does not noticeably alter the color being projected to the signaled pixel, nor does it noticeably degrade the overall image projected to the display surface. So, the user will not notice a degradation of the image. In some embodiments, however, it is desirable for the controller 14 to communicate other data to the icon D1, D_{N} after the icon is located on the display surface 18. When subsequent data communication from the controller 14 to the icon D1, D_{N} is desirable, the controller 14 can project data signals to the icon D1, D_{N} during the data period that do not correspond to the desired color to be displayed on the signaled pixel. Using the data period to communicate data signals to the icons D1, D_{N} instead of projecting the desired color to the display surface may, in fact, noticeably alter the viewable image on the display surface 12. However, the icon D1, D_{N} receiving the data signals is necessarily covering the signaling pixels from view, thus hiding the altered portion of the image from the user's view. Accordingly, such alternation of the image on the display surface does not affect the user's impression of the image, since the user cannot see the altered portion.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. In a digital light projection system, a method of determining the location of a movable icon on a display surface, comprising:
projecting modulated light to the display surface to generate a viewable image; and
projecting an identifiable optical signal to said display surface with said viewable image such that said viewable image is not observably degraded, said identifiable optical signal being receivable by the icon.

2. The method of claim 1, wherein said identifiable optical signal is identifiable by one of a unique frequency, a unique duty cycle, a unique phase, a unique amplitude, and a unique color.

3. The method of claim 1, wherein said identifiable optical signal is projected to a pixel on the display surface for a period of time in place of a color signal used to partially create the viewable image on the display surface.

4. The method of claim 1, wherein said identifiable optical signal is generated for a given pixel during a signaling period and a desired shade of a color for said pixel is generated during a data period, said signaling period and said data period occurring sequentially during a single pass of a single color of a color wheel in front of a light source.

5. The method of claim 1, wherein said identifiable optical signal is projected to a column of pixels on the display surface simultaneously, and wherein said identifiable optical signal is projected to a row of pixels on the display surface simultaneously, wherein said optical signal is projected to said column of pixels at a time different from when said optical signal is projected to said row of pixels.

6. The method of claim 1, further comprising the steps:
sequentially projecting said identifiable optical signal to each of the columns of pixels, column by column, within a defined area on the display surface; and
sequentially projecting said identifiable optical signal to each of the rows of pixels, row by row, within a defined area on the display surface.

7. The method of claim 6, wherein said defined area is the entire display surface.

8. The method of claim 6, wherein said defined area is a subset of the entire display surface.

9. The method of claim 6, further comprising the step of sending a feedback signal from the icon in response to receiving said identifiable optical signal.

10. The method of claim 9, further comprising the step of identifying the physical location of the icon on the display surface based on the column and row that caused the icon to generate a feedback signal.

11. The method of claim 9, further comprising the step of logically dividing the display surface into a plurality of defined areas, and simultaneously projecting said identifiable optical signal to the pixels in one of the defined areas.

12. The method of claim 11, further sequentially repeating the step of simultaneously projecting said identifiable optical signal for each of the plurality of defined areas, area by area.

13. The method of claim 12, further comprising the step of identifying a defined area wherein the icon is physically located.

14. The method of claim 13, wherein said steps of sequentially projecting said identifiable optical signal to columns and rows, column by column and row by row, respectively, are performed only with respect to columns and rows that fall within a defined area known to contain the icon.

15. In a digital light projection system, a method of determining the location of a movable icon on a display surface, comprising:
projecting modulated light to the display surface to generate a viewable image;
projecting an identifiable optical signal to said display surface with said viewable image such that said viewable image is not observably degraded, said identifiable optical signal being receivable by the icon;
wherein said identifiable optical signal is sequentially projected to each of the columns of pixels, column by column, within a defined area on the display surface; and
wherein said identifiable optical signal is sequentially projected to each of the rows of pixels, row by row, within a defined area on the display surface.

16. The method of claim 15, wherein said defined area is the entire display surface.

17. The method of claim 15, wherein said defined area is a subset of the entire display surface.

18. The method of claim 15, further comprising the step of logically dividing the display surface into a plurality of defined areas; simultaneously projecting said identifiable optical signal to the pixels of one of said defined areas; and sequentially repeating said simultaneous projection of said identifiable optical signal to each of the plurality of defined areas, area by area.

19. The method of claim 15, further comprising the icon generating a feedback signal in response to receiving said identifiable optical signal; and identifying a defined area wherein the icon physically resides.

20. The method of claim 19, wherein said steps of sequentially projecting said identifiable optical signal to the columns and rows of pixels, column by column and row by row, respectively, is only performed for said defined area wherein the icon physically resides.

21. A system for determining the location of a movable icon on a display surface, comprising:
a digital light modulator;
a controller configured to cause said digital light modulator to project a viewable image to the display surface and to project an identifiable optical signal to the display surface with the viewable image, such that the identifiable optical signal does not noticeably degrade the viewable image; and
said controller further being configured to cause said digital light modulator to project said identifiable optical signal to the pixels of each column of an area of the display surface, column by column, and to project said identifiable optical signal to the pixels of each row of an area of the display surface, row by row.

22. The system of claim 21, wherein said controller is further configured to cause said digital light modulator to project said identifiable optical signal to the pixels of a plurality of defined areas of the display surface, area by area; and wherein said controller is configured to identify a defined area wherein the icon physically resides.

23. The system of claim 22, wherein said controller is further configured to sequentially project said identifiable optical signal to columns and rows of pixels, column by column and row by row, respectively, only to those columns and rows within a defined area wherein the icon physically resides.

24. A system for determining the location of a movable icon on a display surface, comprising:
a means for projecting modulated light to the display surface; and
a means for causing said projecting means to project an identifiable optical signal to columns of pixels on the display surface, column by column, and for causing said projecting means to project said identifiable optical signal to rows of pixels on the display surface, row by row, said optical signal being projected to the display surface with a viewable image such that the identifiable optical signal does not noticeably alter the viewable image.
